(19) United States
(12) Patent Application Publication
(10) Pub. No.: US 2022/0314408 A1
(43) Pub. Date: Oct. 6, 2022

(54) RAPID DISASSEMBLING DEVICE FOR MECHANICAL KEYBOARD SHAFT BODY

(71) Applicant: Guopeng CHEN, Guangzhou (CN)

(72) Inventor: Zhijie HUANG, Guangzhou (CN)

(21) Appl. No.: 17/621,683

(22) PCT Filed: Apr. 8, 2021
(86) PCT No.: PCT/CN2021/085869

§ 371 Date: Dec. 22, 2021

(30) Foreign Application Priority Data
Apr. 8, 2020 (CN) 202020507055.2

(51) Int. Cl. B25B 27/14; H01H 13/88; B25B 11/02

(52) U.S. Cl. CPC B25B 27/14; H01H 13/88; B25B 11/02

(57) ABSTRACT

A quick disassembling device for keyboard switches of a mechanical keyboard includes a supporting base (1) with a hollow inside and a cube shape. One side of the supporting base (1), that is, the first side, is formed with a cross-shaped distribution the disassembling column (2) and the supporting column (3) are supported by the supporting column (3) to realize the position support and fixing of the keyboard switches, and then the disassembling column (2) can be used to disassemble the keyboard switches. The purpose of quickly disassembling the keyboard switches without damaging the keyboard switches is achieved, the disassembling is quick, convenient and labor-saving, and the adjustment hole (4) facilitates the partial disassembling of the keyboard switches in the supporting base (1).

### TECHNICAL FIELD

The present invention relates to the technical field of mechanical keyboards, in particular to a quick disassembling device for keyboard switches of a mechanical keyboard.

### BACKGROUND

With the development of electronic sports and the upgrading of digital consumption, people have higher requirements for the stable pressing feel and good triggering of computer keyboards. The resistance of the mechanical keyboard is strong and, which can produce a special feel suitable for gaming and entertainment. The mechanical keyboard is the most preferred high-end gaming peripheral for people. In order to ensure that the mechanical keyboard feels suitable, it is particularly important to maintain the keyboard switches of the mechanical keyboard regularly. When performing mechanical keyboard care, both keyboard switches lubrication and spring replacement need to be disassembled before proceeding, and there is no mainstream disassembling tool currently. Usually, many people use tweezers or a flat-blade screwdriver to disassemble. The operation is very inconvenient, and because the force is difficult to finely control, it may also damage the buckle of the keyboard switches during disassembling, making the entire keyboard switches scrapped. In addition, the mechanical keyboard has a maximum of 108 keys, even if you use tweezers or screwdrivers to assist in disassembling, it is extremely time-consuming and labor-intensive. If it is in the electronic sports industry where there is a need for centralized maintenance, the workload and working time required for maintenance processing are even more astonishing.

In summary, the main problems of the keyboard switches of the current mechanical keyboard is that the disassembling method is difficult, time-consuming, and easy to damage the keyboard switches.

### SUMMARY OF THE INVENTION

The purpose of the present invention is to provide a quick disassembling device for the keyboard switches of a mechanical keyboard in order to solve the above-mentioned problems, which has the advantages of being able to quickly disassemble the keyboard switches without damaging the keyboard switches, etc., which are listed as detailed below.

In order to achieve the above objective, the present invention provides the following technical solutions: the present invention provides a quick disassembling device for the keyboard switches of a mechanical keyboard, including a supporting base with a hollow inside and a cube shape, one side of the supporting base, that is, the first side, is formed with a disassembling column and a supporting column distributed in a cross shape.

With adopting the above structure, when the keyboard switches are placed on the supporting base in the correct position, the keyboard switches are positionally supported and fixed by the supporting column, and then a downward force is applied to the upper end of the keyboard switches, at this time, due to the downward displacement of the keyboard switches, the nested buckle part of the keyboard switches will be invaded by the tip of the disassembling column through the gap, the end of the outer buckle of the upper cover of the keyboard switches will also be laterally offset along the top of the disassembling column, so that the outer buckle of the upper cover is separated from the inner buckle of the lower cover. Thereby achieving the purpose of disassembling the nesting relationship between two components. It only needs to put the keyboard switches on the tool and simultaneously press the upper cover and the switch cap to apply downward force, the disassembling can be easily completed, thereby achieving the purpose of quickly disassembling the switch without damaging the keyboard switches, the disassembling is fast, convenient and labor-saving.

Preferably, the four disassembling columns are arranged in a symmetrical array with each other centered on the supporting column, and the each top of the four disassembling columns is provided with an arc slide on the outer side thereof.

Preferably, the first side surface of the supporting base is opening, and a side surface of the supporting base opposite to the first side surface is penetrated with an adjustment hole.

Preferably, a slot is provided on the inner side of the top end of the supporting column.

Preferably, the supporting base is provided with a disassembling column and a supporting column distributed in a cross shape on the second side surface perpendicular to the first side surface.

Preferably, the two disassembling columns are symmetrically distributed with the supporting column as the center, and the top ends of the two disassembling columns are all provided with smooth slideway on the outer side.

Preferably, the supporting base including a first base and a second base, and the outer shape of the first base and the second base is both rectangular cuboid shape, a perforation penetrates through one of the corners of the first base and the second base, the other three corners of the first base and the second base are respectively provided with a first magnet and a second magnet.

The beneficial effect of the present invention is that the position support and fixation of the keyboard switches is realized by the supporting column, and the disassembling of the keyboard switches is realized by cooperating with the disassembling column. The disassembling can be easily completed by applying downward force to the top of the keyboard switches, the disassembling is quick, convenient and labor-saving, and the adjustment hole is convenient to lead out the partially disassembled keyboard switches in the supporting base.

### DESCRIPTION OF THE DRAWINGS

In order to explain the embodiments of the present invention or the technical solutions in the prior art more clearly, the following will briefly introduce the drawings that need to be used in the description of the embodiments or the prior art. Obviously, the drawings in the following description are only some embodiments of the present invention. For those ordinary skill in the art, other drawings can be obtained based on these drawings without creative work.

FIG. 1 is a front view of embodiment 1 of the present invention;

FIG. 1 is a top view of FIG. 1 of the present invention;

FIG. 1 is a perspective view of FIG. 1 of the present invention;

FIG. 1 is a schematic structural view of embodiment 2 of the present invention;

FIG. 1 is a schematic structural view of embodiment 3 of the present invention.

### DETAILED DESCRIPTION

In order to make the objectives, technical solutions and advantages of the present invention clearer, the technical solutions of the present invention will be described in detail below. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

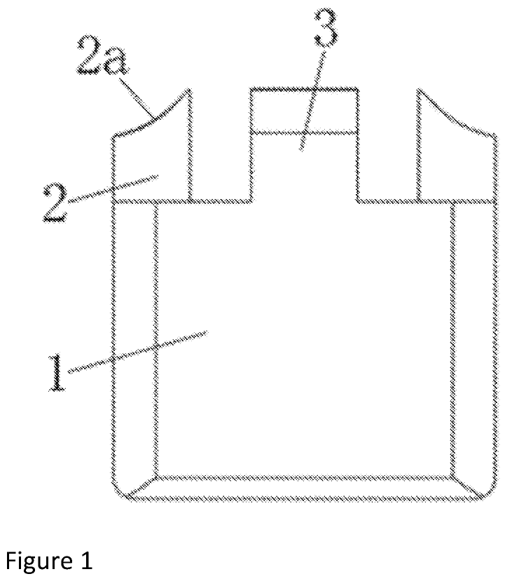

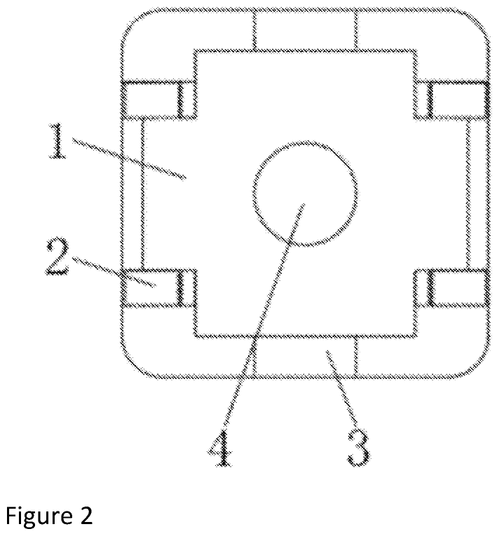

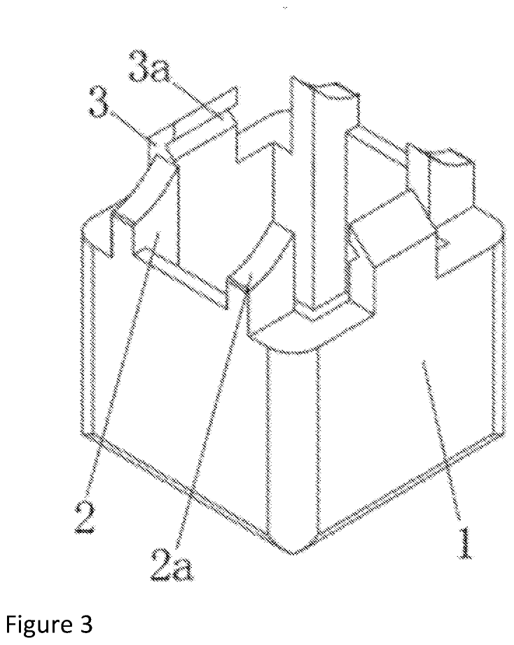

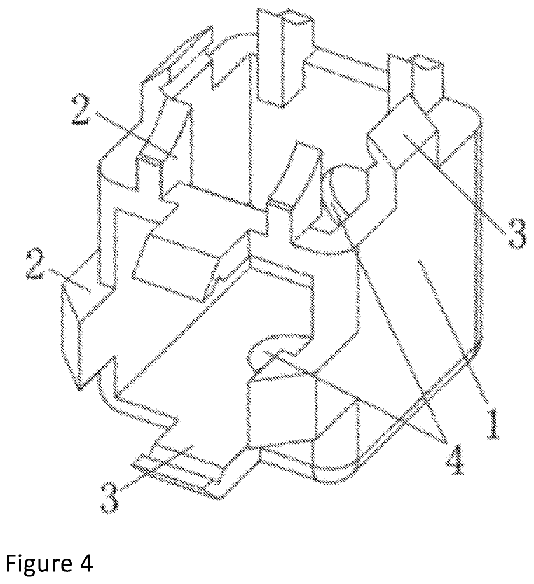

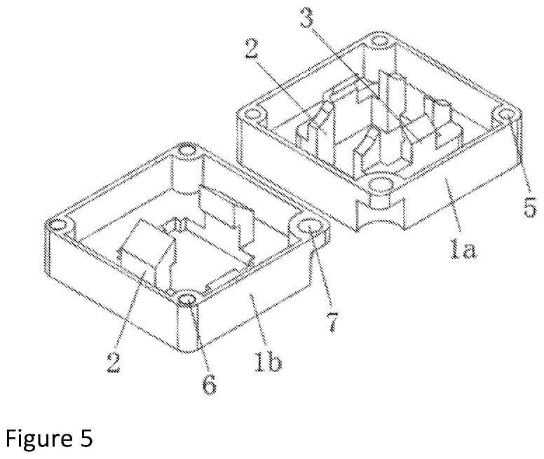

Embodiment 1: refer to FIG. 1 to FIG. 3, the present invention provides a quick disassembling device for keyboard switches of a mechanical keyboard, including a supporting base 1 with a hollow inside and a cube shape, one side of the supporting base 1, that is, the first side, is formed with disassembling column 2 and supporting column 3 distributed in a cross shape. A slot 3a is provided on the inner side of the top end of the supporting column 3. The protruding structure of the lower cover of the keyboard switches is fixed by the slot 3a provided on the inner side of the supporting column 3 due to the overall sinking of the keyboard switches, and the convex structure of the lower cover of the keyboard switches will keep the current position unchanged. So far, the upper cover and the lower cover of the keyboard switches are completely separated, and the disassembling is completed.

The four disassembling columns 2 are arranged in a symmetrical array with each other centered on the supporting column 3, and the each top of the four disassembling columns 2 is provided with an arc slide 2a on the outer side thereof.

The first side surface of the supporting base 1 is open, and a side surface of the supporting base 1 opposite to the first side surface is penetrated with an adjustment hole 4. If the keyboard switches is too stable in the support base 1 after disassembling and cannot be taken out, a small rod can be used to push it out through the adjustment hole 4.

The four buckles of the Cherry MX switch and the Cherry MX switch-like can be matched with the four disassembling columns 2 one by one. When the switch is placed on the disassembling tool, the four disassembling columns 2 and two supporting columns 3 together play a supporting role.

Embodiment 2: refer to FIG. 4, the present invention provides a quick disassembling device for keyboard switches of a mechanical keyboard, including a supporting base 1 with a hollow inside and a cube shape, one side of the supporting base 1, that is, the first side, is formed with disassembling column 2 and supporting column 3 distributed in a cross shape.

The supporting base 1 is provided with a disassembling column 2 and a supporting column 3 distributed in a cross shape on the second side surface perpendicular to the first side surface. The two disassembling columns 2 are symmetrically distributed with the supporting column 3 as the center, and the top ends of the two disassembling columns 2 are all provided with smooth slideway on the outer side.

The disassembling structure of the Kailh switch is equipped with two disassembling columns 2, which form a cross-symmetrical structure with the supporting columns 3, and the ground of the base is kept flat and smooth to ensure the stability during the disassembling process.

1. Embodiment 3: refer to FIG. 5, the present invention provides a supporting base 1 with a hollow inside and a cube shape, one side of the supporting base 1, that is, the first side, is formed with disassembling column 2 and supporting column 3 distributed in a cross shape.

The supporting base 1 includes a first base 1a and a second base 1b, and the outer shape of the first base 1a and the second base 1b is both rectangular cuboid shape, a perforation 7 penetrates through one of the corners of the first base 1a and the second base 1b, the other three corners of the first base 1a and the second base 1b are respectively provided with a first magnet 5 and a second magnet 6.

The first base 1a and the second base 1b are bonded together, and the two are placed opposite each other. The first magnet 5 and the second magnet 6 are attracted to each other through N-pole and S-pole magnetism, and they can be combined into a complete switch tester to exert the function of testing switch. One corner of the first base 1a and the second base 1b is perforated. After the two components are combined, a string can be stringed through the perforation 7 as a keychain decoration, which is convenient to carry.

The position of the keyboard switches is supported and fixed by the supporting column 3, and the disassembling column 2 is used to realize the disassembling of the keyboard switches. The disassembling can be easily completed by applying downward force to the top of the keyboard switches, thereby achieving the purpose of quickly dissembling the keyboard switches without damaging the keyboard switches, dissembling is fast, convenient and labor-saving, and the adjustment hole 4 facilitates the partial disassembling of the keyboard switches in the support base 1 to be led out.

The above are only specific embodiments of the present invention, but the protection scope of the present invention is not limited thereto. Any person skilled in the art can easily think of changes or substitutions within the technical scope disclosed by the present invention. It should be covered within the protection scope of the present invention. Therefore, the protection scope of the present invention should be subject to the protection scope of the claims.

1. A quick disassembling device for keyboard switches of a mechanical keyboard, wherein including a supporting base (1) with a hollow inside and a cube shape, one side of the supporting base (1), that is, the first side, is formed with disassembling column (2) and supporting column (3) distributed in a cross shape.

2. The quick disassembling device for keyboard switches of a mechanical keyboard according to claim 1, wherein the four disassembling columns (2) are arranged in a symmetrical array with each other centered on the supporting column (3), and the each top of the four disassembling columns (2) is provided with an arc slide (2a) on the outer side thereof.

3. The quick disassembling device for keyboard switches of a mechanical keyboard according to claim 1, wherein the first side surface of the supporting base (1) is open, and a side surface of the supporting base (1) opposite to the first side surface is penetrated with an adjustment hole (4).

4. The quick disassembling device for keyboard switches of a mechanical keyboard according to claim 1, wherein a slot (3a) is provided on the inner side of the top end of the supporting column (3).

5. The quick disassembling device for keyboard switches of a mechanical keyboard according to claim 1, wherein the supporting base (1) is provided with a disassembling column (2) and a supporting column (3) distributed in a cross shape on the second side surface perpendicular to the first side surface.

6. The quick disassembling device for keyboard switches of a mechanical keyboard according to claim 5, wherein the two disassembling columns (2) are symmetrically distributed with the supporting column (3) as the center, and each top end of the two disassembling columns (2) is provided with smooth slideway on the outer side.

7. The quick disassembling device for keyboard switches of a mechanical keyboard according to claim 1, wherein the supporting base (1) including a first base (1a) and a second base (1b), and the outer shape of the first base (1a) and the second base (1b) is both rectangular cuboid shape, a perforation (7) penetrates through one of the corners of the first base (1a) and the second base (1b), the other three corners of the first base (1a) and the second base (1b) are respectively provided with a first magnet (5) and a second magnet (6).
